(19) United States
(12) Patent Application Publication
(10) Pub. No.: US 2023/0300951 A1
(43) Pub. Date: Sep. 21, 2023

(54) COOKING DEVICE HAVING A MODULAR CERAMIC HEATER

(71) Applicant: LEXMARK INTERNATIONAL, INC., Lexington, KY (US)

(72) Inventors: JERRY WAYNE SMITH, IRVINE, KY (US); DAVID ANTHONY SCHNEIDER, LEXINGTON, KY (US); JICHANG CAO, LEXINGTON, KY (US)

(21) Appl. No.: 18/203,209

(22) Filed: May 30, 2023

Related U.S. Application Data
(63) Continuation of application No. 17/147,921, filed on Jan. 13, 2021.
(60) Provisional application No. 63/064,028, filed on Aug. 11, 2020.
(60) Provisional application No. 62/972,284, filed on Feb. 10, 2020.

(51) Int. Cl. H05B 3/14; H05B 3/28; H05B 3/26; H05B 3/74

(52) U.S. Cl. CPC H05B 3/141; H05B 3/265; H05B 3/283; H05B 3/748; H05B 2203/01; H05B 2203/013

(57) ABSTRACT

A cooking device according to one example embodiment includes a plurality of modular heaters. Each modular heater includes a ceramic substrate and an electrically resistive trace positioned on the ceramic substrate. Each modular heater is configured to generate heat when an electric current is supplied to the electrically resistive trace. The cooking device includes a thermally conductive heating plate. The plurality of modular heaters are positioned against a bottom surface of the heating plate. The heating plate includes a top surface positioned to transfer heat provided by the plurality of modular heaters to a cooking vessel for cooking an item held by the cooking vessel.

### CROSS REFERENCES TO RELATED APPLICATIONS

This application is a continuation application of U.S. Pat. Application Serial No. 17/147,921, filed Jan. 13, 2021, entitled “Cooking Device Having a Modular Ceramic Heater,” which claims priority to U.S. Provisional Pat. Application Serial No. 62/972,284, filed Feb. 10, 2020, entitled “Modular Ceramic Heater” and to U.S. Provisional Pat. Application Serial No. 63/064,028, filed Aug. 11, 2020, entitled “Modular Ceramic Heater,” the contents of which are hereby incorporated by reference in their entirety.

### BACKGROUND

### 1. Field of the Disclosure

The present disclosure relates to a modular ceramic heater and applications thereof.

### 2. Description of the Related Art

Many heaters used in appliances, such as cooking appliances, washing appliances requiring heated water, health and beauty appliances requiring heat (e.g., hair irons), and automotive heaters, generate heat by passing an electrical current through a resistive element. These heaters often suffer from long warmup and cooldown times due to high thermal mass resulting from, for example, electrical insulation materials and relatively large metal components that serve as heat transfer elements to distribute heat from the heater(s). Manufacturers of such heaters are continuously challenged to improve heating and cooling times and overall heating performance. The need to improve heating performance must be balanced with commercial considerations such as minimizing manufacturing cost and maximizing production capacity.

Accordingly, a cost-effective heater assembly having improved warmup and cooldown times is desired.

### SUMMARY

A cooking device according to one example embodiment includes a plurality of modular heaters. Each modular heater includes a ceramic substrate and an electrically resistive trace positioned on the ceramic substrate. Each modular heater is configured to generate heat when an electric current is supplied to the electrically resistive trace. The cooking device includes a thermally conductive heating plate. The plurality of modular heaters are positioned against a bottom surface of the heating plate. The heating plate includes a top surface positioned to transfer heat provided by the plurality of modular heaters to a cooking vessel for cooking an item held by the cooking vessel.

A cooking device according to another example embodiment includes a base having a top surface positioned to contact a cooking vessel configured to hold an item for cooking. The base includes a thermally conductive heating plate and a plurality of modular heaters positioned against a bottom surface of the heating plate. Each modular heater includes a ceramic substrate and an electrically resistive trace positioned on the ceramic substrate. Each modular heater is configured to generate heat when an electric current is supplied to the electrically resistive trace. The heating plate is positioned to transfer heat provided by the plurality of modular heaters to the top surface of the base for heating the cooking vessel.

Embodiments include those wherein the electrically resistive trace of each modular heater is positioned on an exterior surface of the ceramic substrate. In some embodiments, the electrically resistive trace of each modular heater includes an electrical resistor material thick film printed on the exterior surface of the ceramic substrate.

In some embodiments, the plurality of modular heaters directly contact the bottom surface of the heating plate.

In some embodiments, each of the plurality of modular heaters includes substantially the same construction.

Embodiments include those wherein the electrically resistive trace of each modular heater is positioned on a bottom surface of the ceramic substrate that faces away from the bottom surface of the heating plate.

In some embodiments, at least one of the plurality of modular heaters includes a thermistor positioned on the ceramic substrate and in electrical communication with control circuitry of the modular heater for providing feedback regarding a temperature of the modular heater to the control circuitry of the modular heater.

Some embodiments include a thermistor positioned on the heating plate and in electrical communication with control circuitry of the plurality of modular heaters for providing feedback regarding a temperature of the heating plate to the control circuitry of the plurality of modular heaters.

### BRIEF DESCRIPTION OF THE DRAWINGS

The accompanying drawings incorporated in and forming a part of the specification illustrate several aspects of the present disclosure and together with the description serve to explain the principles of the present disclosure.

FIGS. 1 and 2 are plan views of an inner face and an outer face, respectively, of a ceramic heater according to a first example embodiment.

FIG. 3 is a cross-sectional view of the heater shown in FIGS. 1 and 2 taken along line 3-3 in FIG. 1.

FIGS. 4 and 5 are plan views of an outer face and an inner face, respectively, of a ceramic heater according to a second example embodiment.

FIG. 6 is a plan view of an outer face of a ceramic heater according to a third example embodiment.

FIG. 7 is a plan view of an inner face of a ceramic heater according to a fourth example embodiment.

FIG. 8 is a plan view of an inner face of a ceramic heater according to a fifth example embodiment.

FIG. 9 is a plan view of a first array of heaters according to the example embodiment shown in FIG. 4 and a second array of heaters according to the example embodiment shown in FIG. 6.

FIG. 10 is a schematic depiction of a cooking device according to one example embodiment.

FIG. 11 is an exploded view of a heater assembly of the cooking device shown in FIG. 10 according to one example embodiment.

FIG. 12 is a bottom perspective view of the heater assembly shown in FIG. 11.

FIG. 13 is a schematic depiction of a hot plate according to one example embodiment.

FIG. 14 is a bottom plan view of a heater assembly of the hot plate shown in FIG. 13 according to one example embodiment.

FIG. 15 is a schematic depiction of a hair iron according to one example embodiment.

FIG. 16 is an exploded diagram of an automotive heater according to one example embodiment.

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

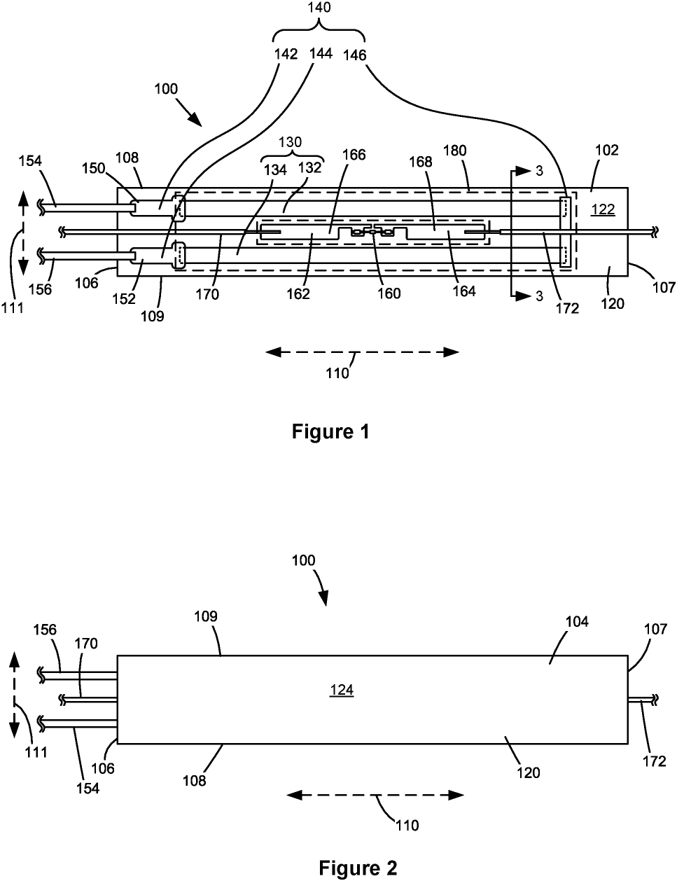

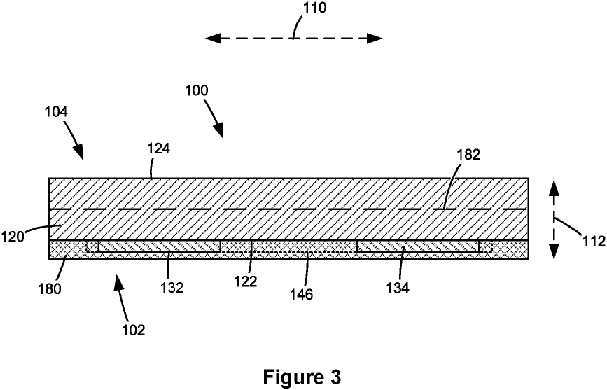

With reference to FIGS. 1 and 2, a heater 100 is shown according to one example embodiment. FIG. 1 shows an inner face 102 of heater 100, and FIG. 2 shows outer face 104 of heater 100. Typically, inner face 102 faces away from the object being heated by heater 100, and outer face 104 faces toward the object being heated by heater 100. For example, where heater 100 is used in a cooking appliance, outer side 104 of heater 100 may face toward a heat transfer element, such as a metal plate, that transfers heat to a cooking vessel that holds the food or other item to be cooked, and inner side 102 of heater 100 may face away from the heat transfer element. Further, electrical connections to heater 100 are typically made with terminals on inner face 102 of heater 100. In the embodiment illustrated, inner face 102 and outer face 104 are bordered by four sides or edges, including lateral edges 106 and 107 and longitudinal edges 108 and 109, each having a smaller surface area than inner face 102 and outer face 104. In this embodiment, inner face 102 and outer face 104 are rectangular; however, other shapes may be used as desired (e.g., other polygons such as a square). In the embodiment illustrated, heater 100 includes a longitudinal dimension 110 that extends from lateral edge 106 to lateral edge 107 and a lateral dimension 111 that extends from longitudinal edge 108 to longitudinal edge 109. Heater 100 also includes an overall thickness 112 (FIG. 3) measured from inner face 102 to outer face 104.

Heater 100 includes one or more layers of a ceramic substrate 120, such as aluminum oxide (e.g., commercially available 96% aluminum oxide ceramic). Ceramic substrate 120 includes an outer face 124 that is oriented toward outer face 104 of heater 100 and an inner face 122 that is oriented toward inner face 102 of heater 100 . Outer face 124 and inner face 122 of ceramic substrate 120 are positioned on exterior portions of ceramic substrate 120 such that if more than one layer of ceramic substrate 120 is used, outer face 124 and inner face 122 are positioned on opposed external faces of the ceramic substrate 120 rather than on interior or intermediate layers of ceramic substrate 120.

In the example embodiment illustrated, outer face 104 of heater 100 is formed by outer face 124 of ceramic substrate 120 as shown in FIG. 2. In this embodiment, inner face 122 of ceramic substrate 120 includes a series of one or more electrically resistive traces 130 and electrically conductive traces 140 positioned thereon. Resistive traces 130 include a suitable electrical resistor material such as, for example, silver palladium (e.g., blended 70/30 silver palladium). Conductive traces 140 include a suitable electrical conductor material such as, for example, silver platinum. In the embodiment illustrated, resistive traces 130 and conductive traces 140 are applied to ceramic substrate 120 by way of thick film printing. For example, resistive traces 130 may include a resistor paste having a thickness of 10-13 microns when applied to ceramic substrate 120, and conductive traces 140 may include a conductor paste having a thickness of 9-15 microns when applied to ceramic substrate 120. Resistive traces 130 form the heating element of heater 100 and conductive traces 140 provide electrical connections to and between resistive traces 130 in order to supply an electrical current to each resistive trace 130 to generate heat.

In the example embodiment illustrated, heater 100 includes a pair of resistive traces 132, 134 that extend substantially parallel to each other (and substantially parallel to longitudinal edges 108, 109) along longitudinal dimension 110 of heater 100. Heater 100 also includes a pair of conductive traces 142, 144 that each form a respective terminal 150, 152 of heater 100. Cables or wires 154, 156 may be connected to terminals 150, 152 in order to electrically connect resistive traces 130 and conductive traces 140 to a voltage source and control circuitry that selectively closes the circuit formed by resistive traces 130 and conductive traces 140 to generate heat. Conductive trace 142 directly contacts resistive trace 132, and conductive trace 144 directly contacts resistive trace 134. Conductive traces 142, 144 are both positioned adjacent to lateral edge 106 in the example embodiment illustrated, but conductive traces 142, 144 may be positioned in other suitable locations on ceramic substrate 120 as desired. In this embodiment, heater 100 includes a third conductive trace 146 that electrically connects resistive trace 132 to resistive trace 134, e.g., adjacent to lateral edge 107. Portions of resistive traces 132, 134 obscured beneath conductive traces 142, 144, 146 in FIG. 1 are shown in dotted line. In this embodiment, current input to heater 100 at, for example, terminal 150 by way of conductive trace 142 passes through, in order, resistive trace 132, conductive trace 146, resistive trace 134, and conductive trace 144 where it is output from heater 100 at terminal 152. Current input to heater 100 at terminal 152 travels in reverse along the same path.

In some embodiments, heater 100 includes a thermistor 160 positioned in close proximity to a surface of heater 100 in order to provide feedback regarding the temperature of heater 100 to control circuitry that operates heater 100. In some embodiments, thermistor 160 is positioned on inner face 122 of ceramic substrate 120. In the example embodiment illustrated, thermistor 160 is welded directly to inner face 122 of ceramic substrate 120. In this embodiment, heater 100 also includes a pair of conductive traces 162, 164 that are each electrically connected to a respective terminal of thermistor 160 and that each form a respective terminal 166, 168. Cables or wires 170, 172 may be connected to terminals 166, 168 in order to electrically connect thermistor 160 to, for example, control circuitry that operates heater 100 in order to provide closed loop control of heater 100. In the embodiment illustrated, thermistor 160 is positioned at a central location of inner face 122 of ceramic substrate 120, between resistive traces 132, 134 and midway from lateral edge 106 to lateral edge 107. In this embodiment, conductive traces 162, 164 are also positioned between resistive traces 132, 134 with conductive trace 102 positioned toward lateral edge 106 from thermistor 160 and conductive trace 164 positioned toward lateral edge 107 from thermistor 160. However, thermistor 160 and its corresponding conductive traces 162, 164 may be positioned in other suitable locations on ceramic substrate 120 so long as they do not interfere with the positioning of resistive traces 130 and conductive traces 140.

FIG. 3 is a cross-sectional view of heater 100 taken along line 3-3 in FIG. 1. With reference to FIGS. 1-3, in the embodiment illustrated, heater 100 includes one or more layers of printed glass 180 on inner face 122 of ceramic substrate 120. In the embodiment illustrated, glass 180 covers resistive traces 132, 134, conductive trace 146, and portions of conductive traces 142, 144 in order to electrically insulate such features to prevent electric shock or arcing. The borders of glass layer 180 are shown in dashed line in FIG. 1. In this embodiment, glass 180 does not cover thermistor 160 or conductive traces 162, 164 because the relatively low voltage applied to such features presents a lower risk of electric shock or arcing. An overall thickness of glass 180 may range from, for example, 70-80 microns. FIG. 3 shows glass 180 covering resistive traces 132, 134 and adjacent portions of ceramic substrate 120 such that glass 180 forms the majority of inner face 102 of heater 100. Outer face 124 of ceramic substrate 120 is shown forming outer face 104 of heater 100 as discussed above. Conductive trace 146, which is obscured from view in FIG. 3 by portions of glass 180, is shown in dotted line. FIG. 3 depicts a single layer of ceramic substrate 120. However, ceramic substrate 120 may include multiple layers as depicted by dashed line 182 in FIG. 3.

Heater 100 may be constructed by way of thick film printing. For example, in one embodiment, resistive traces 130 are printed on fired (not green state) ceramic substrate 120, which includes selectively applying a paste containing resistor material to ceramic substrate 120 through a patterned mesh screen with a squeegee or the like. The printed resistor is then allowed to settle on ceramic substrate 120 at room temperature. The ceramic substrate 120 having the printed resistor is then heated at, for example, approximately 140-160° C. for a total of approximately 30 minutes, including approximately 10-15 minutes at peak temperature and the remaining time ramping up to and down from the peak temperature, in order to dry the resistor paste and to temporarily fix resistive traces 130 in position. The ceramic substrate 120 having temporary resistive traces 130 is then heated at, for example, approximately 850° C. for a total of approximately one hour, including approximately 10 minutes at peak temperature and the remaining time ramping up to and down from the peak temperature, in order to permanently fix resistive traces 130 in position. Conductive traces 140 and 162, 164 are then printed on ceramic substrate 120, which includes selectively applying a paste containing conductor material in the same manner as the resistor material. The ceramic substrate 120 having the printed resistor and conductor is then allowed to settle, dried and fired in the same manner as discussed above with respect to resistive traces 130 in order to permanently fix conductive traces 140 and 162, 164 in position. Glass layer(s) 180 are then printed in substantially the same manner as the resistors and conductors, including allowing the glass layer(s) 180 to settle as well as drying and firing the glass layer(s) 180. In one embodiment, glass layer(s) 180 are fired at a peak temperature of approximately 810° C., slightly lower than the resistors and conductors. Thermistor 160 is then mounted to ceramic substrate 120 in a finishing operation with the terminals of thermistor 160 directly welded to conductive traces 162, 164.

Thick film printing resistive traces 130 and conductive traces 140 on fired ceramic substrate 120 provides more uniform resistive and conductive traces in comparison with conventional ceramic heaters, which include resistive and conductive traces printed on green state ceramic. The improved uniformity of resistive traces 130 and conductive traces 140 provides more uniform heating across outer face 104 of heater 100 as well as more predictable heating of heater 100.

While the example embodiment illustrated in FIGS. 1-3 includes resistive traces 130 and thermistor 160 positioned on inner face 122 of ceramic substrate 120, in other embodiments, resistive traces 130 and/or thermistor 160 may be positioned on outer face 124 of ceramic substrate 120 along with corresponding conductive traces as needed to establish electrical connections thereto. Glass 180 may cover the resistive traces and conductive traces on outer face 124 and/or inner face 122 of ceramic substrate 120 as desired in order to electrically insulate such features.

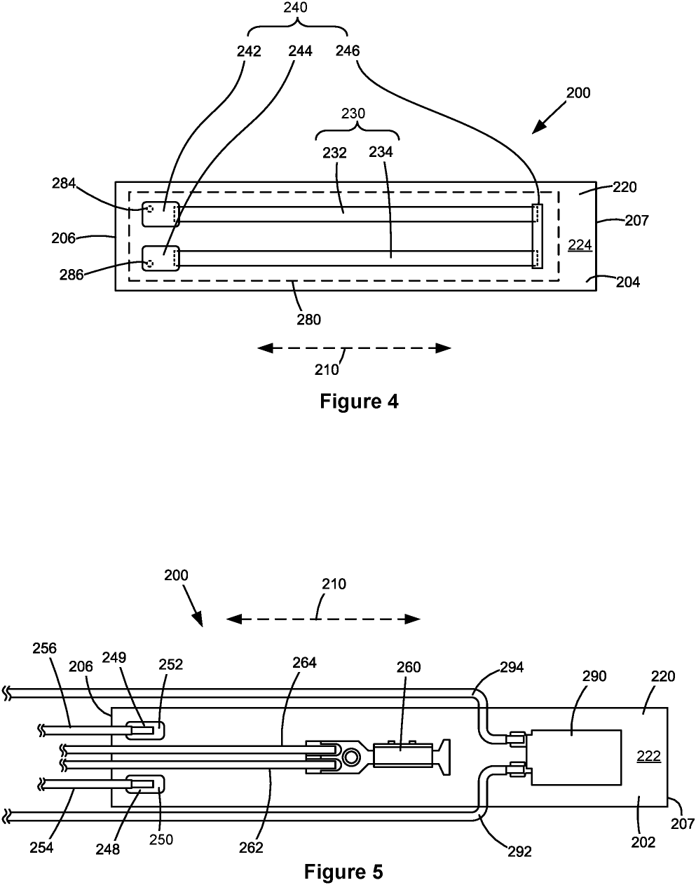

FIGS. 4 and 5 show a heater 200 according to another example embodiment. Heater 200 includes an inner face 202 and an outer face 204. Heater 200 includes one or more layers of ceramic substrate 220 as discussed above. Ceramic substrate 220 includes an inner face 222 that is oriented toward inner face 202 of heater 200 and an outer face 204 that is oriented toward outer face 224 of heater 200. In contrast with the embodiment shown in FIGS. 1-3, in the example embodiment illustrated in FIGS. 4 and 5, electrically resistive traces 230 and electrically conductive traces 240 are positioned on outer face 224 of ceramic substrate 220 rather than inner face 222. Resistive traces 230 and conductive traces 240 may be applied by way of thick film printing as discussed above.

As shown in FIG. 4, in the example embodiment illustrated, heater 200 includes a pair of resistive traces 232, 234 on outer face 224 of ceramic substrate 220. Resistive traces 232, 234 extend substantially parallel to each other along a longitudinal dimension 210 of heater 200. Heater 200 also includes three conductive traces 242, 244, 246 positioned on outer face 224 of ceramic substrate 220. Conductive trace 242 directly contacts resistive trace 232, and conductive trace 244 directly contacts resistive trace 234. Conductive traces 242, 244 are both positioned adjacent to a first lateral edge 206 of heater 200 in the example embodiment illustrated. Conductive trace 246 is positioned adjacent to a second lateral edge 207 of heater 200 and electrically connects resistive trace 232 to resistive trace 234. Portions of resistive traces 232, 234 obscured beneath conductive traces 242, 244, 246 in FIG. 4 are shown in dotted line.

In the embodiment illustrated, heater 200 includes a pair of vias 284, 286 that are formed as through-holes substantially filled with conductive material extending through ceramic substrate 220 from outer face 224 to inner face 222. Vias 284, 286 electrically connect conductive traces 242, 244 to corresponding conductive traces on inner face 222 of ceramic substrate 220 as discussed below.

In the embodiment illustrated, heater 200 includes one or more layers of printed glass 280 on outer face 224 of ceramic substrate 220. In the embodiment illustrated, glass 280 covers resistive traces 232, 234 and conductive traces 242, 244, 246 in order to electrically insulate these features. The borders of glass layer 280 are shown in dashed line in FIG. 4.

FIG. 5 shows inner face 202 of heater 200 according to one example embodiment. In this embodiment, heater 200 includes a pair of conductive traces 248, 249 positioned on inner face 222 of ceramic substrate 220 that each form a respective terminal 250, 252 of heater 200. Each conductive trace 248, 249 on inner face 222 of ceramic substrate 220 is electrically connected to a respective conductive trace 242, 244 on outer face 224 of ceramic substrate 220 by a respective via 284, 286. Cables or wires 254, 256 may be connected to (e.g., directly welded to) terminals 250, 252 in order to supply current to resistive traces 232, 234 to generate heat. In this embodiment, current input to heater 200 at, for example, terminal 250 by way of conductive trace 248 passes through, in order, via 284, conductive trace 242, resistive trace 232, conductive trace 246, resistive trace 234, conductive trace 244, via 286 and conductive trace 249 where it is output from heater 200 at terminal 252. Current input to heater 200 at terminal 252 travels in reverse along the same path.

In the example embodiment illustrated, heater 200 includes a thermistor 260 positioned in close proximity to inner face 222 of ceramic substrate 220 in order to provide feedback regarding the temperature of heater 200 to control circuitry that operates heater 200. In this embodiment, thermistor 260 is not directly attached to ceramic substrate 220 but is instead held against inner face 222 of ceramic substrate 220 by a mounting clip (not shown) or other fixture or attachment mechanism. Cables or wires 262, 264 are connected to (e.g., directly welded to) respective terminals of thermistor 260 in order to electrically connect thermistor 260 to, for example, control circuitry that operates heater 200. Of course, thermistor 260 of heater 200 may alternatively be directly welded to ceramic substrate 220 as discussed above with respect to thermistor 160 of heater 100. Similarly, thermistor 160 of heater 100 may be held against ceramic substrate 120 by a fixture instead of directly welded to ceramic substrate 120.

In the example embodiment illustrated, heater 200 also includes a thermal cutoff 290, such as a bi-metal thermal cutoff, positioned on inner face 222 of ceramic substrate 220. Cables or wires 292, 294 are connected to respective terminals of thermal cutoff 290 in order to provide electrical connections to thermal cutoff 290. Thermal cutoff 290 is electrically connected in series with the heating circuit formed by resistive traces 230 and conductive traces 240 permitting thermal cutoff 290 to open the heating circuit formed by resistive traces 230 and conductive traces 240 upon detection by thermal cutoff 290 of a temperature that exceeds a predetermined amount. In this manner, thermal cutoff 290 provides additional safety by preventing overheating of heater 200. Of course, heater 100 discussed above may also include a thermal cutoff as desired.

While not illustrated, it will be appreciated that inner face 222 of ceramic substrate 220 may include one or more glass layers in order to electrically insulate portions of inner face 202 of heater 200 as desired.

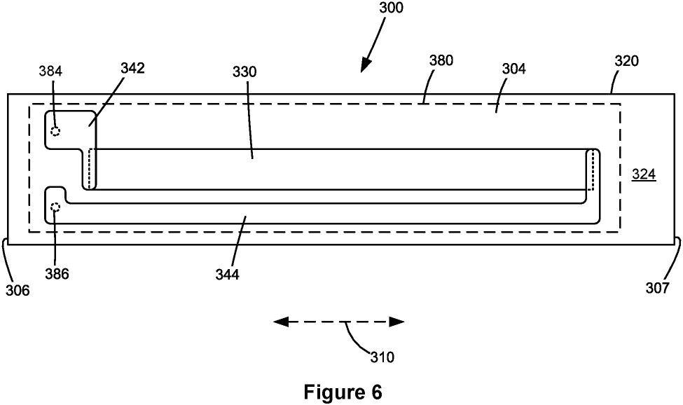

FIG. 6 shows a heater 300 according to another example embodiment. FIG. 6 shows an outer face 304 of heater 300. In one embodiment, an inner face of heater 300 is substantially the same as inner face 202 of heater 200 shown in FIG. 5. Heater 300 includes one or more layers of a ceramic substrate 320 as discussed above. FIG. 6 shows an outer face 324 of ceramic substrate 320.

In the example embodiment illustrated, heater 300 includes a single resistive trace 330 on outer face 324 of ceramic substrate 320. Resistive trace 330 extends along a longitudinal dimension 310 of heater 300. Heater 300 also includes a pair of conductive traces 342, 344 positioned on outer face 324 of ceramic substrate 320. Each conductive trace 342, 344 directly contacts a respective end of resistive trace 330. Conductive trace 342 contacts resistive trace 330 near a first lateral edge 306 of heater 300. Conductive trace 344 contacts resistive trace 330 near a second lateral edge 307 of heater 300 and extends from the point of contact with resistive trace 330 to a position next to conductive trace 342. Portions of resistive trace 330 obscured beneath conductive traces 342, 344 in FIG. 6 are shown in dotted line.

In the embodiment illustrated, heater 300 includes a pair of vias 384, 386 that are formed as through-holes substantially filled with conductive material extending through ceramic substrate 320 as discussed above with respect to heater 200. Vias 384, 386 electrically connect conductive traces 342, 344 to corresponding conductive traces on the inner face of ceramic substrate 320 as discussed above.

In the embodiment illustrated, heater 300 includes one or more layers of printed glass 380 on outer face 324 of ceramic substrate 320. Glass 380 covers resistive trace 330 and conductive traces 342, 344 in order to electrically insulate these features as discussed above. The borders of glass layer 380 are shown in dashed line in FIG. 6.

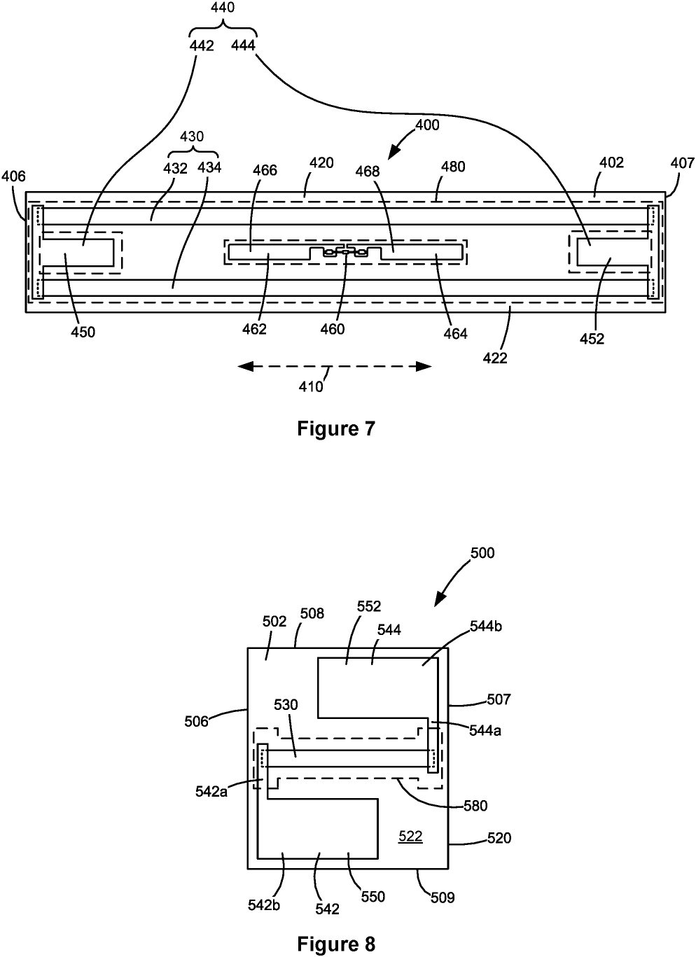

FIG. 7 shows a heater 400 according to another example embodiment. FIG. 7 shows an inner face 402 of heater 400. Heater 400 includes one or more layers of a ceramic substrate 420 as discussed above. In one embodiment, an outer face of heater 400 is substantially the same as outer face 104 of heater 100 shown in FIG. 2 such that an outer face of ceramic substrate 420 forms an outer face of heater 400. FIG. 7 shows an inner face 422 of ceramic substrate 420. In this embodiment, inner face 422 of ceramic substrate 420 includes a series of electrically resistive traces 430 and electrically conductive traces 440 positioned thereon. Resistive traces 430 and conductive traces 440 may be applied to ceramic substrate 420 by way of thick film printing as discussed above.

In the example embodiment illustrated, heater 400 includes a pair of resistive traces 432, 434 that extend substantially parallel to each other along a longitudinal dimension 410 of heater 400. Heater 400 also includes a pair of conductive traces 442, 444 that each form a respective terminal 450, 452 of heater 400. As discussed above, cables or wires may be connected to terminals 450, 452 in order to electrically connect resistive traces 430 and conductive traces 440 to a voltage source and control circuitry that operates heater 400. Conductive trace 442 directly contacts resistive traces 432, 434 near a first lateral edge 406 of heater 400, and conductive trace 444 directly contacts resistive traces 432, 434 near a second lateral edge 407 of heater 400. Portions of resistive traces 432, 434 obscured beneath conductive traces 442, 444 in FIG. 7 are shown in dotted line. In this embodiment, current input to heater 400 at, for example, terminal 450 by way of conductive trace 442 passes through resistive traces 432 and 434 to conductive trace 444 where it is output from heater 400 at terminal 452. Current input to heater 400 at terminal 452 travels in reverse along the same path.

In the embodiment illustrated, heater 400 also includes a thermistor 460 positioned on inner face 422 of ceramic substrate 420. In the example embodiment illustrated, thermistor 460 is welded directly to inner face 422 of ceramic substrate 420. In this embodiment, heater 400 also includes a pair of conductive traces 462, 464 that are each electrically connected to a respective terminal of thermistor 460 and that each form a respective terminal 466, 468. Cables or wires may be connected to terminals 466, 468 in order to electrically connect thermistor 460 to, for example, control circuitry that operates heater 400 in order to provide closed loop control of heater 400. In the embodiment illustrated, heater 400 includes one or more layers of printed glass 480 on inner face 422 of ceramic substrate 420. In the embodiment illustrated, glass 480 covers resistive traces 432, 434, and portions of conductive traces 442, 444 in order to electrically insulate such features. The borders of glass layer 480 are shown in dashed line in FIG. 7.

FIG. 8 shows a heater 500 according to another example embodiment. FIG. 8 shows an inner face 502 of heater 500. Heater 500 includes one or more layers of a ceramic substrate 520 as discussed above. In one embodiment, an outer face of ceramic substrate 520 forms an outer face of heater 500. FIG. 8 shows an inner face 522 of ceramic substrate 520. In the embodiment illustrated, inner face 502 and outer face of heater 500 are square shaped. In this embodiment, inner face 522 of ceramic substrate 520 includes an electrically resistive trace 530 and a pair of electrically conductive traces 542, 544 positioned thereon. Resistive trace 530 and conductive traces 542, 544 may be applied to ceramic substrate 520 by way of thick film printing as discussed above.

In the example embodiment illustrated, resistive trace 530 extends from near a first edge 506 of heater 500 toward a second edge 507 of heater 500, substantially parallel to third and fourth edges 508, 509 of heater 500. In this embodiment, resistive trace 530 is positioned midway between edges 508, 509 of heater 500. Conductive traces 542, 544 each form a respective terminal 550, 552 of heater 500. As discussed above, cables or wires may be connected to terminals 550, 552 in order to electrically connect resistive traces 530 and conductive traces 542, 544 to a voltage source and control circuitry that operates heater 500. Conductive trace 542 directly contacts a first end of resistive trace 530 near edge 506 of heater 500, and conductive trace 544 directly contacts a second end of resistive trace 530 near edge 507 of heater 500. Conductive trace 542 includes a first segment 542a that extends from the first end of resistive trace 530 toward edge 509 of heater 500, along edge 506 of heater 500. Conductive trace 542 also includes a second segment 542b that extends from first segment 542a of conductive trace 542 toward edge 507 of heater 500, along edge 509 of heater 500, and parallel to resistive trace 530. Conductive trace 544 includes a first segment 544a that extends from the second end of resistive trace 530 toward edge 508 of heater 500, along edge 507 of heater 500. Conductive trace 544 also includes a second segment 544b that extends from first segment 544a of conductive trace 544 toward edge 506 of heater 500, along edge 508 of heater 500, and parallel to resistive trace 530. Portions of resistive trace 530 obscured beneath conductive traces 542, 544 in FIG. 8 are shown in dotted line. In this embodiment, current input to heater 500 at, for example, terminal 550 by way of second segment 542b of conductive trace 542 passes through first segment 542a of conductive trace 542, to resistive trace 530, to first segment 544a of conductive trace 544, to second segment 544b of conductive trace 544 where it is output from heater 500 at terminal 552. Current input to heater 500 at terminal 552 travels in reverse along the same path.

In the embodiment illustrated, heater 500 includes one or more layers of printed glass 580 on inner face 522 of ceramic substrate 520. In the embodiment illustrated, glass 580 covers resistive trace 530 and portions of first segments 542a, 544a of conductive traces 542, 544 in order to electrically insulate such features. The borders of glass layer 580 are shown in dashed line in FIG. 8. Although not shown, as discussed above, heater 500 may also include a thermistor on inner face 522 or the outer face of heater 500 in order to provide closed loop control of heater 500. The thermistor may be fixed to heater 500 (e.g., to ceramic substrate 520) or held against heater 500 as desired.

The embodiments illustrated and discussed above with respect to FIGS. 1-8 are intended as examples and are not exhaustive. The heaters of the present disclosure may include resistive and conductive traces in many different patterns, layouts, geometries, shapes, positions, sizes and configurations as desired, including resistive traces on an outer face of the heater, an inner face of the heater and/or an intermediate layer of the ceramic substrate of the heater. Other components (e.g., a thermistor and/or a thermal cutoff) may be positioned on or against a face of the heater as desired. As discussed above, ceramic substrates of the heater may be provided in a single layer or multiple layers, and various shapes (e.g., rectangular, square or other polygonal faces) and sizes of ceramic substrates may be used as desired. In some embodiments where the heater includes a ceramic substrate having rectangular faces, a length of the ceramic substrate along a longitudinal dimension may range from, for example, 80 mm to 120 mm, and a width of the ceramic substrate along a lateral dimension may range from, for example, 15 mm to 24 mm. In some embodiments where the heater includes a ceramic substrate having square faces, a length and width of the ceramic substrate may range from, for example, 5 mm to 25 mm (e.g., a 10 mm by 10 mm square). Curvilinear shapes may be used as well but are typically more expensive to manufacture. Printed glass may be used as desired on the outer face and/or the inner face of the heater to provide electrical insulation.

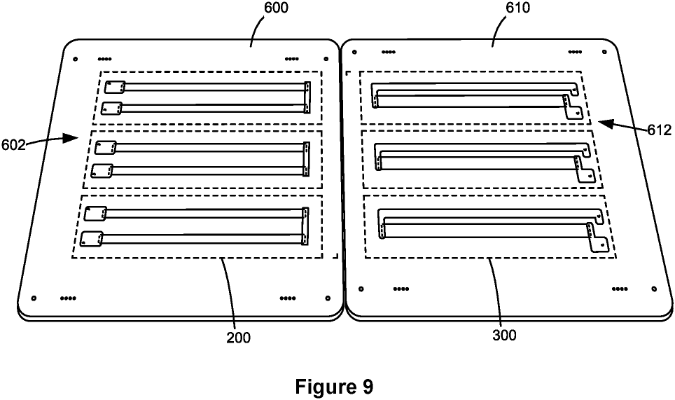

The heaters of the present disclosure are preferably produced in an array for cost efficiency with each heater in a particular array having substantially the same construction. Preferably, each array of heaters is separated into individual heaters after the construction of all heaters in the array is completed, including firing of all components and any applicable finishing operations. In some embodiments, individual heaters are separated from the array by way of fiber laser scribing. Fiber laser scribing tends to provide a more uniform singulation surface having fewer microcracks along the separated edge in comparison with conventional carbon dioxide laser scribing. As an example, FIG. 9 shows a first panel 600 including an array 602 of heaters 200 according to the example embodiment shown in FIG. 4 and a second panel 610 including an array 612 of heaters 300 according to the example embodiment shown in FIG. 6.

In order to minimize cost and manufacturing complexity, it is preferable to standardize the sizes and shapes of the heater panels and the individual heaters in order to produce arrays of modular heaters. As an example, panels, such as panels 600, 610, may be prepared in rectangular or square shapes, such as 2″ by 2″ or 4″ by 4″ square panels or larger 165 mm by 285 mm rectangular panels. The thickness of each layer of the ceramic substrate may range from 0.3 mm to 2 mm. For example, commercially available ceramic substrate thicknesses include 0.3 mm, 0.635 mm, 1 mm, 1.27 mm, 1.5 mm, and 2 mm. Another approach is to construct the heaters in non-standard or custom sizes and shapes to match the heating area required in a particular application. However, for larger heating applications, this approach generally increases the manufacturing cost and material cost of the heaters significantly in comparison with constructing modular heaters in standard sizes and shapes.

One or more modular heaters may be mounted to or positioned against a heat transfer element having high thermal conductivity to provide heat to a desired heating area. The heaters may be produced according to standard sizes and shapes with the heat transfer element sized and shaped to match the desired heating area. In this manner, the size and shape of the heat transfer element can be specifically tailored or adjusted to match the desired heating area rather than customizing the size and shape of the heater(s). The number of heaters attached to or positioned against the heat transfer element can be selected based on the desired heating area and the amount of heat required.

The heat transfer element can be formed from a variety of high thermal conductivity materials, such as aluminum, copper, or brass. In some embodiments, aluminum is advantageous due to its relatively high thermal conductivity and relatively low cost. Aluminum that has been hot forged into a desired shape is often preferable to cast aluminum due to the higher thermal conductivity of forged aluminum.

Heat transfer may be improved by applying a gap filler, such as a thermal pad, adhesive or grease, between adjoining surfaces of each heater and the heat transfer element in order to reduce the effects of imperfections of these surfaces on heat transfer. Thermally insulative pads may be applied portions of the heaters that face away from the heat transfer element (e.g., the inner face of each heater) in order to reduce heat loss, improving heating efficiency. Springs or other biasing features that force the heaters toward the heat transfer element may also be used to improve heat transfer.

The heaters of the present disclosure are suitable for use in a wide range of commercial applications including, for example, heating plates for cooking devices such as rice cookers or hot plates; washing appliances such as dish washers and clothes washers; health and beauty appliances such as flat irons, straightening irons, curling irons, and crimping irons; and automotive heaters such as cabin heaters. Various example commercial applications are discussed below; however, the examples discussed below are not intended to be exhaustive or limiting.

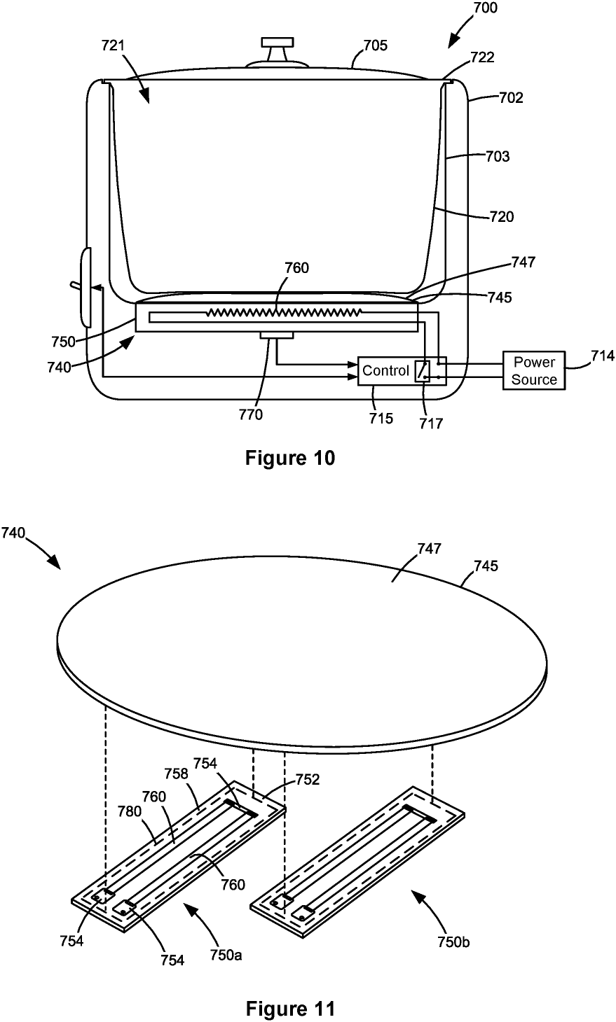

FIG. 10 shows an example commercial application of the heaters of the present disclosure including a cooking device 700 according to one example embodiment. In the example embodiment illustrated, cooking device 700 includes a rice cooker. However, cooking device 700 may include a pressure cooker, a steam cooker, or other cooking appliances. Cooking device 700 includes a housing 702, a cooking vessel 720 and a heater assembly 740. Housing 702 includes an upper portion having a receptacle 703 for receiving cooking vessel 720 and a lower portion within which heater assembly 740 is mounted. In the embodiment illustrated, heater assembly 740 forms a receiving base of receptacle 703 such that cooking vessel 720 contacts and rests on top of heater assembly 740 when cooking vessel 720 is positioned within receptacle 703 so that heat generated by heater assembly 740 heats cooking vessel 720. Cooking vessel 720 is generally a container (e.g., a bowl) having a food receptacle 721 in which food substances to be cooked, such as rice and water, are contained. A lid 705 may cover the opening at a rim 722 of cooking vessel 720.

Heater assembly 740 includes one or more modular heaters 750 (e.g., one or more of heaters 100, 200, 300, 400, 500 discussed above) and a heating plate 745 which serves as a heat transfer element to transfer heat from heaters 750 to cooking vessel 720. Each heater 750 includes one or more resistive traces 760 which generate heat when an electrical current is passed through the resistive trace(s) 760. Each heater 750 of heater assembly 740 may have substantially the same construction. Heating plate 745 is composed of a thermally conductive material, such as forged aluminum, as discussed above. When cooking vessel 120 is disposed in receptacle 703, cooking vessel 720 contacts and rests on top of heating plate 745. Heater(s) 750 are positioned against, either in direct contact with or in very close proximity to, heating plate 745 in order to transfer heat generated by heater(s) 750 to cooking vessel 720. As discussed above, in some embodiments, a thermal gap filler is applied between each heater 750 and heating plate 745 to facilitate physical contact and heat transfer between heater(s) 750 and heating plate 745.

Cooking device 700 includes control circuitry 715 configured to control the temperature of heater(s) 750 by selectively opening or closing one or more circuits supplying electrical current to heater(s) 750. Open loop or, preferably, closed loop control may be utilized as desired. In the embodiment illustrated, a temperature sensor 770, such as a thermistor, is coupled to each heater 750 and/or to heating plate 745 for sensing the temperature thereof and permitting closed loop control of heater(s) 750 by control circuitry 715. Control circuitry 715 may include a microprocessor, a microcontroller, an application-specific integrated circuit, and/or other form integrated circuit. In the example embodiment illustrated, control circuitry 715 includes a switch 717 that selectively opens and closes the circuit(s) of heater(s) 750 in order to control the heat generated by heater(s) 750. Switch 717 may be, for example, a mechanical switch, an electronic switch, a relay, or other switching device. Control circuitry 715 uses the temperature information from temperature sensor(s) 770 to control switch 717 to selectively supply power to resistive trace(s) 760 based on the temperature information. When switch 717 is closed, current flows through resistive trace(s) 760 to generate heat from heater(s) 750. When switch 717 is open, no current flows through resistive trace(s) 760 to pause or stop heat generation from heater(s) 750. Where cooking device 700 includes more than one heater 750, heaters 750 may be controlled independently or jointly. In some embodiments, control circuitry 715 may include power control logic and/or other circuitries for controlling the amount of power delivered to resistive trace(s) 760 to permit adjustment of the amount of heat generated by heater(s) 750 within a desired range of temperatures.

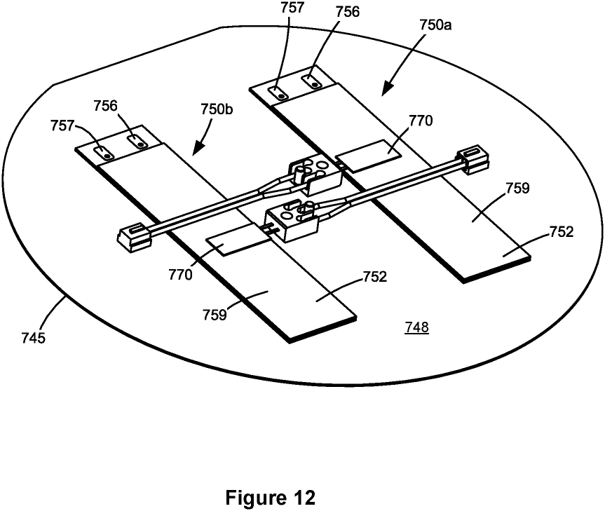

FIGS. 11 and 12 show heater assembly 740 including heating plate 745 and a pair of heaters 750, designated 750a, 750b, according to one example embodiment. FIG. 11 is an exploded view of heater assembly 740, and FIG. 12 shows a bottom perspective view of heater assembly 740. In the example embodiment illustrated, heating plate 745 is formed as a circular disk having a domed top surface 747 (also shown in FIG. 10 with exaggerated scale for illustration purposes). In one embodiment, heating plate 745 has a diameter of about 162 mm, a central portion having a thickness of about 5 mm, and a circumferential edge having a thickness of about 1 mm. In other embodiments, heating plate 745 may have other shapes as long as heating plate 745 is positioned to spread heat from heaters 750 across the bottom surface of cooking vessel 720. The thermal conductivity and relative thinness of heating plate 745 result in a relatively low thermal mass, which reduces the amount of time required to heat and cool heating plate 745 and, in turn, cooking vessel 720.

In the example embodiment illustrated, a pair (750a, 750b) of heaters 750 are positioned against a bottom surface 748 of heating plate 745. However, heater assembly 740 may include more or fewer heaters 750 as desired depending on the heating requirements of cooking device 700. Each heater 750 includes a ceramic substrate 752 having a series of one or more electrically resistive traces 760 and electrically conductive traces 754 positioned thereon as discussed above. Heat is generated when electrical current provided by a power source 714 (FIG. 10) is passed through resistive trace(s) 760. In the example embodiment illustrated, resistive traces 760 are positioned on an outer face 758 of heater 750 that faces toward heating plate 745. However, as desired, resistive traces 760 may be positioned on an inner face 759 of heater 750 that faces away from heating plate 745 and/or an intermediate layer of ceramic substrate 752 in addition to or instead of on outer face 758 of heater 750. In the example embodiment illustrated, conductive traces 754 on outer face 758 provide electrical connections to and between resistive traces 760. In this embodiment, conductive traces 754 on inner face 759 are electrically connected to conductive traces 754 on outer face 758 and serve as terminals 756, 757 of heater 750 to electrically connect heater 750 to power source 714 and control circuitry 715. Each heater 750 may include one or more layers of printed glass 780 on outer face 758 and/or inner face 759 in order to electrically insulate resistive traces 760 and conductive traces 754 as desired. Of course, heaters 750 illustrated in FIGS. 11 and 12 are merely examples, and the heaters of cooking device 700 may take many different shapes, positions, sizes and configurations and may include resistive and conductive traces in many different patterns, layouts, geometries, shapes, positions, sizes and configurations as desired.

In the example embodiment illustrated, a thermistor 770 is positioned against an inner face 759 of each heater 750. Thermistors 770 are electrically connected to control circuitry 715 in order to provide closed loop control of heaters 750. While the example embodiment illustrated includes an external thermistor 770 positioned against each heater 750, each heater 750 may instead include a thermistor attached to ceramic substrate 752. As desired, heater assembly 740 may include a thermistor positioned against bottom surface 748 of heating plate 745, either in place of or in addition to thermistors 770 positioned on or against heaters 750. Heater assembly 740 may also include one or more thermal cutoffs as discussed above.

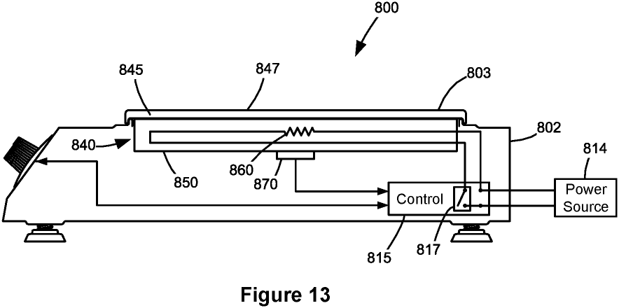

FIG. 13 shows another example commercial application of the heaters of the present disclosure including a cooking device according to another example embodiment. In the example embodiment illustrated, the cooking device includes a hot plate 800. In the example embodiment illustrated, hot plate 800 is a standalone unit that may be used for cooking or for other heating applications, such as the heating of substances or materials in a laboratory. In other embodiments, hot plate 800 may be an integrated component of an appliance such as a cooktop or a cooking range. In some embodiments, hot plate 800 may include a cooking vessel configured to hold the item or substance being heated, e.g., a kettle configured to hold a liquid, as an integrated component with hot plate 800. Hot plate 800 includes a housing 802 and a heater assembly 840. In the embodiment illustrated, housing 802 includes an upper portion having contact surface 803 on which a cooking vessel holding the item or substance being heated by heater assembly 840 rests.

Heater assembly 840 includes one or more modular heaters 850 (e.g., one or more of heaters 100, 200, 300, 400, 500 discussed above) and a heating plate 845 which serves as a heat transfer element to transfer heat from heaters 850 to contact surface 803. Each heater 850 of heater assembly 840 may have substantially the same construction. In some embodiments, a top surface 847 of heating plate 845 forms contact surface 803. In other embodiments, a cover, shield, sleeve, coating or film, preferably composed of a thermally conductive and electrically insulative material (e.g., boron nitride filled polyimide), may cover top surface 847 of heating plate 845 and form contact surface 803. Each heater 850 includes one or more resistive traces 860 which generate heat when an electrical current is passed through the resistive trace(s) 860. Heating plate 845 is composed of a thermally conductive material, such as forged aluminum, as discussed above. Heater(s) 850 are positioned against, either in direct contact with or in very close proximity to, heating plate 845 in order to transfer heat generated by heater(s) 850 to contact surface 803. As discussed above, in some embodiments, a thermal gap filler is applied between each heater 850 and heating plate 845 to facilitate physical contact and heat transfer between heater(s) 850 and heating plate 845.

Hot plate 800 includes control circuitry 815 configured to control the temperature of heater(s) 850 by selectively opening or closing one or more circuits supplying electrical current to heater(s) 850. Open loop or, preferably, closed loop control may be utilized as desired. In the embodiment illustrated, a temperature sensor 870, such as a thermistor, is coupled to each heater 850 and/or to heating plate 845 for sensing the temperature thereof and permitting closed loop control of heater(s) 850 by control circuitry 815. In the example embodiment illustrated, control circuitry 815 includes a switch 817 that selectively opens and closes the circuit(s) of heater(s) 850 in order to control the heat generated by heater(s) 850. Control circuitry 815 uses the temperature information from temperature sensor(s) 870 to control switch 817 to selectively supply power to resistive trace(s) 860 based on the temperature information. Where hot plate 800 includes more than one heater 850, heaters 850 may be controlled independently or jointly.

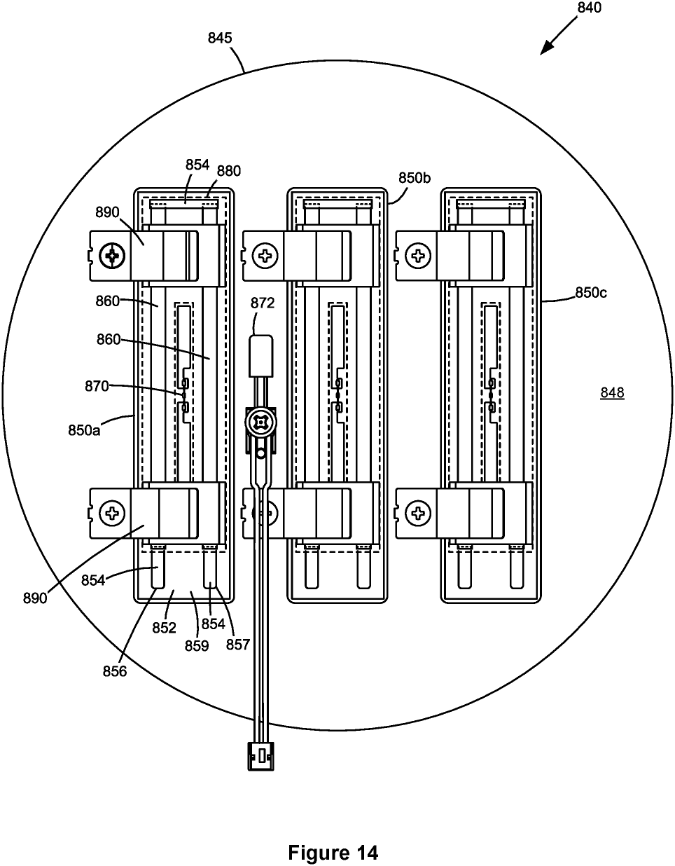

FIG. 14 shows heater assembly 840 including heating plate 845 and a set of three heaters 850, designated 850a, 850b, 850c, according to one example embodiment. In the example embodiment illustrated, heating plate 845 is formed as a circular disk having a substantially flat top surface 847 (FIG. 13). In other embodiments, heating plate 845 may have other shapes and surface geometries (e.g., a domed top surface) as long as heating plate 845 is positioned to spread heat from heaters 850 across contact surface 803.

In the example embodiment illustrated, three (850a, 850b, 850c) heaters 850 are positioned against a bottom surface 848 of heating plate 845. However, heater assembly 840 may include more or fewer heaters 850 as desired depending on the heating requirements of hot plate 800. Each heater 850 includes a ceramic substrate 852 having a series of one or more electrically resistive traces 860 and electrically conductive traces 854 positioned thereon as discussed above. Heat is generated when electrical current provided by a power source 814 (FIG. 13) is passed through resistive trace(s) 860. In the example embodiment illustrated, resistive traces 860 are positioned on an inner face 859 of heater 850 that faces away from heating plate 845. However, as desired, resistive traces 860 may be positioned on an outer face of heater 850 that faces toward heating plate 845 and/or an intermediate layer of ceramic substrate 852 in addition to or instead of on inner face 859 of heater 850. In the example embodiment illustrated, conductive traces 854 on inner face 859 provide electrical connections to and between resistive traces 860 and also serve as terminals 856, 857 of heater 850 to electrically connect each heater 850 to power source 814 and control circuitry 815. Each heater 850 may include one or more layers of printed glass 880 on the outer face of heater 850 and/or inner face 859 in order to electrically insulate resistive traces 860 and conductive traces 854 as desired. Of course, heaters 850 illustrated in FIG. 14 are merely examples, and the heaters of hot plate 800 may take many different shapes, positions, sizes and configurations and may include resistive and conductive traces in many different patterns, layouts, geometries, shapes, positions, sizes and configurations as desired.

In the example embodiment illustrated, a thermistor 870 is positioned against an inner face 859 of each heater 850. Thermistors 870 are electrically connected to control circuitry 815 in order to provide closed loop control of heaters 850. The example embodiment illustrated includes a thermistor 870 attached to the ceramic substrate 852 of each heater 850; however, external thermistors positioned against each heater 850 may be used as desired. In the example embodiment illustrated, heater assembly 840 also includes a thermistor 872 positioned against bottom surface 848 of heating plate 845 in order to provide additional temperature feedback to control circuitry 815. Heater assembly 840 may also include one or more thermal cutoffs as discussed above.

In the example embodiment illustrated, each heater 850 is held against bottom surface 848 of heating plate 845 by one or more mounting clips 890. Mounting clips 890 fixedly position heaters 850 against bottom surface 848 of heating plate 845 and are resiliently deflectable in order to mechanically bias the outer faces of heaters 850 against bottom surface 848 of heating plate 845 in order to facilitate heat transfer from heaters 850 to heating plate 845.

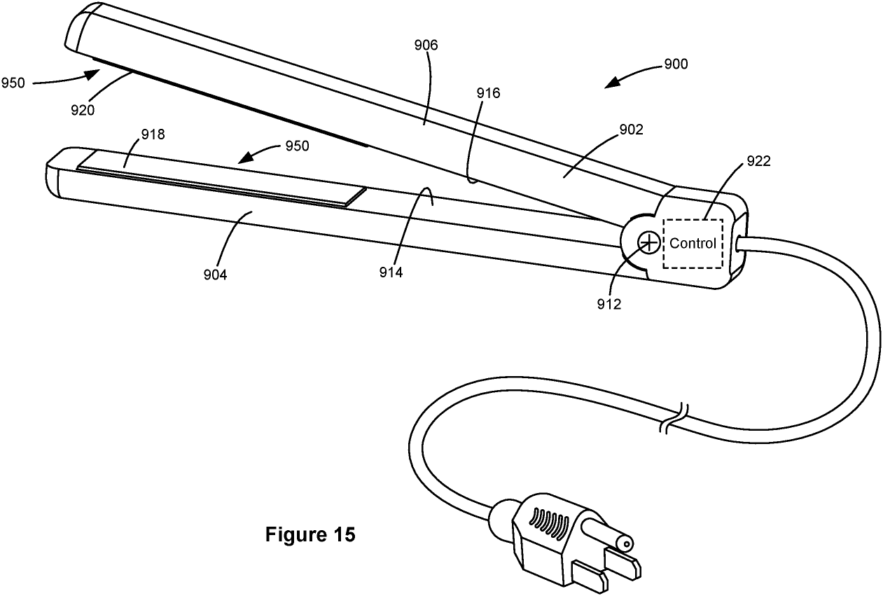

FIG. 15 shows another example commercial application of the heaters of the present disclosure including a hair iron 900 according to one example embodiment. Hair iron 900 may include an appliance such as a flat iron, straightening iron, curling iron, crimping iron, or other similar device that applies heat and pressure to a user’s hair in order to change the structure or appearance of the user’s hair. Hair iron 900 includes a housing 902 that forms the overall support structure of hair iron 900. Housing 902 may be composed of, for example, a plastic that is thermally insulative and electrically insulative and that possesses relatively high heat resistivity and dimensional stability and low thermal mass. Example plastics include polybutylene terephthalate (PBT) plastics, polycarbonate/acrylonitrile butadiene styrene (PC/ABS) plastics, polyethylene terephthalate (PET) plastics, including glass-filled versions of each. In addition to forming the overall support structure of hair iron 900, housing 902 also provides electrical insulation and thermal insulation in order to provide a safe surface for the user to contact and hold during operation of hair iron 900.

Hair iron 900 includes a pair of arms 904, 906 that are movable between an open position shown in FIG. 15 where distal segments of arms 904, 906 are spaced apart from each other and a closed position where distal segments of arms 904, 906 are in contact, or close proximity with each other. For example, in the embodiment illustrated, arms 904, 906 are pivotable relative to each other about a pivot axis 912 between the open position and the closed position.

Hair iron 900 includes one or more modular heaters 950 (e.g., one or more of heaters 100, 200, 300, 400, 500 discussed above), which may have substantially the same construction, positioned on an inner side 914, 916 of one or both of arms 904, 906. Inner sides 914, 916 of arms 904, 906 include the portions of arms 904, 906 that face each other when arms 904, 906 are in the closed position. Heaters 950 supply heat to respective contact surfaces 918, 920 on arms 904, 906. Each contact surface 918, 920 is positioned on inner side 914, 916 of the corresponding arm 904, 906. Contact surfaces 918, 920 may be formed directly by a surface of each heater 950 or formed by a material covering each heater 950, such as a shield or sleeve preferably composed of a thermally conductive and electrically insulative material. Contact surfaces 918, 920 are positioned to directly contact and transfer heat to a user’s hair upon the user positioning a portion of his or her hair between arms 904, 906 and positioning arms 904, 906 in the closed position. Contact surfaces 918, 920 may be positioned to mate against one another in a relatively flat orientation when arms 904, 906 are in the closed position in order to maximize the surface area available for contacting the user’s hair.

Each heater 950 includes one or more resistive traces which generate heat when an electrical current is passed through the resistive traces as discussed above. Hair iron 900 includes control circuitry 922 configured to control the temperature of each heater 950 by selectively opening or closing a circuit supplying electrical current to heater(s) 950. Open loop or, preferably, closed loop control may be utilized as desired. As discussed above, each heater 950 may include a temperature sensor, such as a thermistor, for sensing the temperature thereof and permitting closed loop control of heater(s) 950 by control circuitry 922. Where hair iron 900 includes more than one heater 950, heaters 950 may be controlled independently or jointly.

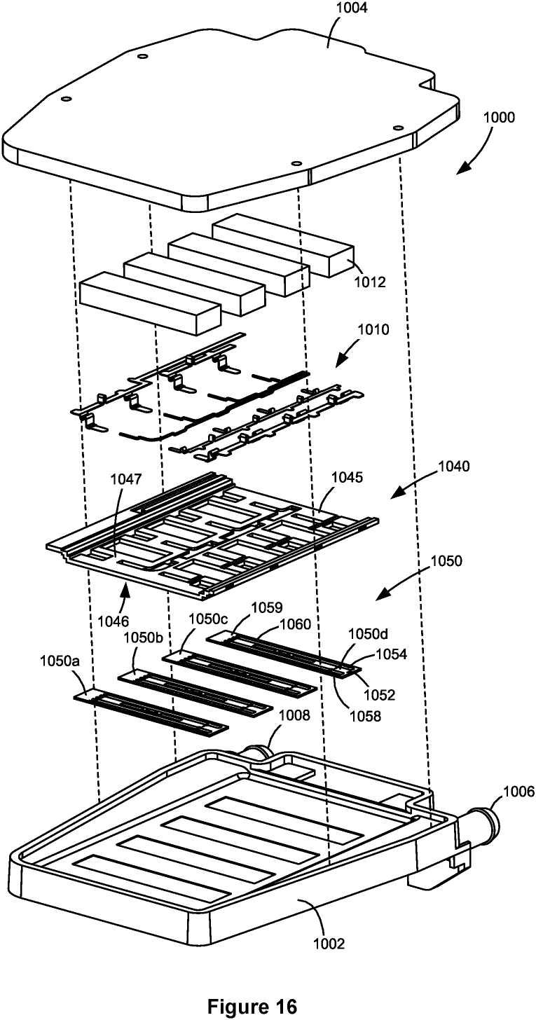

FIG. 16 shows another example commercial application of the heaters of the present disclosure including an automotive heater 1000 according to one example embodiment. In the example embodiment illustrated, automotive heater 1000 heats a fluid, such as coolant, that may be used, for example, to provide heat to the cabin of a vehicle. In the embodiment illustrated, automotive heater 1000 includes a main body 1002 and a lid or cover 1004 that attaches to main body 1002. A heater assembly 1040 of automotive heater 1000 is housed between main body 1002 and cover 1004. Main body 1002 includes a heat exchanger housed therein including a fluid inlet 1006 that permits fluid to enter the heat exchanger for heating by heater assembly 1040 and a fluid outlet 1008 that permits heated fluid to exit the heat exchanger.

Heater assembly 1040 includes one or more modular heaters 1050 (e.g., one or more of heaters 100, 200, 300, 400, 500 discussed above) positioned against a heater frame 1045 which serves as a heat transfer element to transfer heat from heaters 1050 to the heat exchanger of main body 1002. Each heater 1050 of heater assembly 1040 may have substantially the same construction. In the example embodiment illustrated, heater assembly 1040 includes a set of four heaters 1050, designated 1050a, 1050b, 1050c, 1050d, sandwiched between a front side 1046 of heater frame 1045 and main body 1002. Each heater 1050 includes a ceramic substrate 1052 having a series of one or more electrically resistive traces 1060 and electrically conductive traces 1054 positioned thereon as discussed above. Heat is generated when electrical current is passed through resistive trace(s) 1060. Heater frame 1045 is composed of a thermally conductive material, such as forged aluminum, as discussed above. As desired, one or more temperature sensors may be used to provide closed loop control of heaters 1050 as discussed above. Heater assembly 1040 may also include one or more thermal cutoffs as desired. Each heater 1050 may include one or more layers of printed glass for electrical insulation as desired. Of course, heaters 1050 illustrated in FIG. 16 are merely examples, and the heaters of automotive heater 1000 may take many different shapes, positions, sizes and configurations and may include resistive and conductive traces in many different patterns, layouts, geometries, shapes, positions, sizes and configurations as desired.

Heater assembly 1040 includes wires, cables or other electrical conductors 1010, e.g., positioned on heater frame 1045, that provide electrical connections to heater(s) 1050. In the example embodiment illustrated, one or more foam members 1012 are sandwiched between a rear side 1047 of heater frame 1045 and cover 1004. Foam members 1012 thermally insulate inner faces 1059 of heaters 1050 and mechanically bias heaters 1050 against main body 1002 in order to help facilitate heat transfer from outer faces 1058 of heaters 1050 to the heat exchanger of main body 1002.

The present disclosure provides modular ceramic heaters having a low thermal mass in comparison with conventional ceramic heaters. In some embodiments, thick film printed resistive traces on an exterior face (outer or inner) of the ceramic substrate provides reduced thermal mass in comparison with resistive traces positioned internally between multiple sheets of ceramic. The low thermal mass of the modular ceramic heaters of the present disclosure allows the heater(s), in some embodiments, to heat to an effective temperature for use in a matter of seconds (e.g., less than 5 seconds), significantly faster than conventional heaters. The low thermal mass of the modular ceramic heaters of the present disclosure also allows the heater(s), in some embodiments, to cool to a safe temperature after use in a matter of seconds (e.g., less than 5 seconds), again, significantly faster than conventional heaters.

Further, embodiments of the modular ceramic heaters of the present disclosure operate at a more precise and more uniform temperature than conventional heaters because of the closed loop temperature control provided by the temperature sensor(s) in combination with the relatively uniform thick film printed resistive and conductive traces. The low thermal mass of the modular ceramic heaters and improved temperature control permit greater energy efficiency in comparison with conventional heaters. The improved temperature control and temperature uniformity also increase safety by reducing the occurrence of overheating.

The foregoing description illustrates various aspects of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

1. A cooking device, comprising:
a plurality of modular heaters, each modular heater includes a ceramic substrate and an electrically resistive trace positioned on the ceramic substrate, each modular heater is configured to generate heat when an electric current is supplied to the electrically resistive trace; and
a thermally conductive heating plate, the plurality of modular heaters are positioned against a bottom surface of the heating plate, the heating plate includes a top surface positioned to transfer heat provided by the plurality of modular heaters to a cooking vessel for cooking an item held by the cooking vessel,
wherein the ceramic substrate of each modular heater of the plurality of modular heaters is separate and spaced apart from the ceramic substrate(s) of the other modular heater(s) of the plurality of modular heaters.

2. The cooking device of claim 1, wherein the electrically resistive trace of each modular heater is positioned on an exterior surface of the ceramic substrate.

3. The cooking device of claim 2, wherein the electrically resistive trace of each modular heater includes an electrical resistor material thick film printed on the exterior surface of the ceramic substrate.

4. The cooking device of claim 1, wherein the plurality of modular heaters directly contact the bottom surface of the heating plate.

5. The cooking device of claim 1, wherein each of the plurality of modular heaters includes the same construction.

6. The cooking device of claim 1, wherein the electrically resistive trace of each modular heater is positioned on a bottom surface of the ceramic substrate that faces away from the bottom surface of the heating plate.

7. The cooking device of claim 1, wherein at least one of the plurality of modular heaters includes a thermistor positioned directly on the ceramic substrate and in electrical communication with control circuitry of the modular heater for providing feedback regarding a temperature of the modular heater to the control circuitry of the modular heater.

8. The cooking device of claim 7, wherein the thermistor is positioned directly on a bottom surface of the ceramic substrate that faces away from the bottom surface of the heating plate.

9. The cooking device of claim 7, wherein the electrically resistive trace of the at least one modular heater includes a first electrically resistive trace and a second electrically resistive trace, the first electrically resistive trace is electrically connected to the second electrically resistive trace, the first electrically resistive trace and the second electrically resistive trace are electrically connected to a first terminal and a second terminal positioned on the ceramic substrate of the at least one modular heater for connecting the first electrically resistive trace and the second electrically resistive trace to a voltage source, and the thermistor is positioned on the ceramic substrate of the at least one modular heater between the first electrically resistive trace and the second electrically resistive trace.

10. The cooking device of claim 1, further comprising a thermistor positioned directly on the heating plate and in electrical communication with control circuitry of the plurality of modular heaters for providing feedback regarding a temperature of the heating plate to the control circuitry of the plurality of modular heaters.

11. A cooking device, comprising:
a base having a top surface positioned to contact a cooking vessel configured to hold an item for cooking; and
the base includes a thermally conductive heating plate and a plurality of modular heaters positioned against a bottom surface of the heating plate, each modular heater includes a ceramic substrate and an electrically resistive trace positioned on the ceramic substrate, each modular heater is configured to generate heat when an electric current is supplied to the electrically resistive trace, the heating plate is positioned to transfer heat provided by the plurality of modular heaters to the top surface of the base for heating the cooking vessel, the ceramic substrates of the plurality of modular heaters are arranged in a spaced relationship relative to each other.

12. The cooking device of claim 11, wherein the electrically resistive trace of each modular heater is positioned on an exterior surface of the ceramic substrate.

13. The cooking device of claim 12, wherein the electrically resistive trace of each modular heater includes an electrical resistor material thick film printed on the exterior surface of the ceramic substrate.

14. The cooking device of claim 11, wherein the plurality of modular heaters directly contact the bottom surface of the heating plate.

15. The cooking device of claim 11, wherein each of the plurality of modular heaters includes the same construction.

16. The cooking device of claim 11, wherein the electrically resistive trace of each modular heater is positioned on a bottom surface of the ceramic substrate that faces away from the bottom surface of the heating plate.

17. The cooking device of claim 11, wherein at least one of the plurality of modular heaters includes a thermistor positioned directly on the ceramic substrate and in electrical communication with control circuitry of the modular heater for providing feedback regarding a temperature of the modular heater to the control circuitry of the modular heater.

18. The cooking device of claim 17, wherein the thermistor is positioned directly on a bottom surface of the ceramic substrate that faces away from the bottom surface of the heating plate.

19. The cooking device of claim 17, wherein the electrically resistive trace of the at least one modular heater includes a first electrically resistive trace and a second electrically resistive trace, the first electrically resistive trace is electrically connected to the second electrically resistive trace, the first electrically resistive trace and the second electrically resistive trace are electrically connected to a first terminal and a second terminal positioned on the ceramic substrate of the at least one modular heater for connecting the first electrically resistive trace and the second electrically resistive trace to a voltage source, and the thermistor is positioned on the ceramic substrate of the at least one modular heater between the first electrically resistive trace and the second electrically resistive trace.

20. The cooking device of claim 11, further comprising a thermistor positioned directly on the heating plate and in electrical communication with control circuitry of the plurality of modular heaters for providing feedback regarding a temperature of the heating plate to the control circuitry of the plurality of modular heaters.
